(19) United States
(12) Patent Application Publication
(10) Pub. No.: US 2015/0283759 A1
(43) Pub. Date: Oct. 8, 2015

(54) METHOD OF MAKING THREE-DIMENSIONAL OBJECTS USING BIO-RENEWABLE CRYSTALLINE-AMORPHOUS MATERIALS

(71) Applicant: XEROX CORPORATION, Norwalk, CT (US)

(72) Inventors: Adela Goredema, Mississauga (CA); Jennifer L. Belelie, Oakville (CA); Marcel P. Breton, Mississauga (CA); Barkev Keoshkerian, Thornhill (CA)

(73) Assignee: XEROX CORPORATION, Norwalk, CT (US)

(21) Appl. No.: 14/247,466

(22) Filed: Apr. 8, 2014

(51) Int. Cl. B29C 67/00

(52) U.S. Cl. CPC B29C 67/0055; B33Y 10/00; B33Y 30/00; B29L 2009/00

(57) ABSTRACT

A method for forming a three-dimensional object using layer by layer formation of the object through application of stereolithography. More specifically, the formation of a three-dimensional object using a three-dimensional printer based on thermal stereolithography and phase change materials comprising a combination of crystalline and amorphous compounds, that are derived from low cost, stable and bio-renewable materials.

### BACKGROUND

The present embodiments relate generally to the formation of a three-dimensional object using layer by layer formation of the object through application of stereolithography. More specifically, the present embodiments relate to the formation of a three-dimensional object using a three-dimensional printer. To form the three-dimensional object, certain materials are employed which are characterized by being solid at room temperature and molten or flowable at an elevated temperature at which the molten material is applied to form layers. Subsequent deposition of layers upon the first layer generates a three-dimensional object. The material is made flowable upon the application of thermal radiation. Thus, in such embodiments, the three-dimensional printer uses thermal stereolithography to form the three-dimensional objects. In the present embodiments, the materials comprise a combination of crystalline and amorphous compounds, like those described in U.S. Pat. No. 8,506,040, which is hereby incorporated by reference in its entirety. Furthermore, the amorphous compound and crystalline compounds are derived from low cost, stable and bio-renewable materials, thus providing robust three-dimensional objects that are “more sustainable.

Stereolithography is a model building technique that builds three-dimensional objects in layers, as described in U.S. Pat. Nos. 4,575,330 and 4,929,402, which are hereby incorporated by reference in their entireties.

Generally, in stereolithography, a three-dimensional object is formed layer by layer in a stepwise fashion out of a material capable of physical transformation upon exposure to synergistic stimulation. For example, in one embodiment of stereolithography, layers of untransformed material such as liquid photopolymer are successively formed at the working surface of an amount of the liquid photopolymer contained in a container. The untransformed layers are successively formed over previously-transformed material. The untransformed layers are selectively exposed to synergistic stimulation such as UV radiation, or the like, wherein such layers form object layers. After formation into the object layers, the untransformed layers typically adhere to the previously-formed layers through the natural adhesive properties of the photopolymer upon solidification.

More recently, three-dimensional printing to form three-dimensional objects is becoming more popular. Such printing methods can be used to form anything from small parts for household appliances and toys to components for computers and automobiles. In recent years, three-dimensional printers are being used more frequently in both homes and offices. Current three-dimensional printers operate based on thermal stereolithography. The settings that these printers are used within require that the printing materials be non-reactive and non-toxic.

A persistent problem that exists in relation to thermal stereolithography and, in particular, as it relates to three-dimensional printing is finding suitable materials that are capable of being dispensed from the dispensers currently used in such systems (such as an ink jet print head), and which are also capable of forming three-dimensional objects with suitable robustness and accuracy in formation. For example, in thermal stereolithography, there is the need to quickly solidify the flowable material after its dispensed. The time needed for heat to be removed and allow sufficient material solidification limits the ability to lay subsequent layers, since newly dispensed material may deform if not cooled sufficiently before the next layer is dispensed. Thus, this phase change property impacts the overall object build time. Other known materials, such as hot melt inks, are either not sufficiently robust, tend to be brittle, exhibit significant layer to layer distortion, have high viscosities, or other properties that make them difficult to handle and dispense from multiorifice ink jet dispensers such as those which may be used in thermal stereolithography.

Accordingly, it is an object of the present embodiments to provide an apparatus of and method for providing robust three-dimensional objects through application of thermal stereolithography. It is a further object to provide a material that can be used with such apparatus and method to form improved three-dimensional objects that are more robust than those formed with prior known materials and compositions. Lastly, it is a constant desire to find bio-renewable and sustainable materials for use in most industries. Thus, it is also an object of the present embodiments to find such materials for use in forming three-dimensional objects.

### SUMMARY

According to embodiments illustrated herein, there is provided a method for forming three-dimensional objects comprising: providing a phase change material, wherein the phase change material comprises a crystalline compound and an amorphous compound and the phase change material comprises up to 80% bio-renewable content; heating the phase change material to a jetting temperature; jetting the phase change material in layers on top of one another, wherein each layer is allowed to cool and/or solidify before jetting a subsequent layer; and forming a three-dimensional object from the cool and/or solidified layers.

In particular, the present embodiments provide a method for forming three-dimensional objects comprising: providing a phase change material, wherein the phase change material comprises a crystalline compound and an amorphous compound and the phase change material comprises up to 80% bio-renewable content; heating the phase change material to a jetting temperature; jetting the phase change material to form a first layer; allowing the first layer to cool and/or solidify; and selectively jetting subsequent layers onto the first layer, either partially or entirely, wherein each layer is allowed to cool and/or solidify before jetting the next layer; and forming a three-dimensional object from the cool and/or solidified layers.

In yet other embodiments, there is provided a system for forming three-dimensional objects comprising: a phase change material, wherein the phase change material comprises a crystalline compound and an amorphous compound and the phase change material comprises up to 80% bio-renewable content; and a three dimensional printer comprising a reservoir for holding the phase change material, a heating element for heating the phase change material to a jetting temperature, and a printhead for jetting the phase change material in successive layers to form a three-dimensional object.

### BRIEF DESCRIPTION OF THE DRAWINGS

For a better understanding of the present embodiments, reference may be made to the accompanying figures.

FIG. 1 is a graph illustrating rheology data of an aromatic rosin ester according to the present embodiments; and

FIG. 2 provides the rheology profile for three phase change materials made according to the present embodiments.

### DETAILED DESCRIPTION

In the following description, it is understood that other embodiments may be utilized and structural and operational changes may be made without departure from the scope of the present embodiments disclosed herein.

Three-dimensional printing to generate three-dimensional objects is gaining popularity across many markets, and the possibilities for its use continue to expand as the technology improves. The present embodiments provide an apparatus of and method for providing three-dimensional objects through application of stereolithography, using solid materials which are made molten or flowable upon the application of thermal radiation such as heat. The present embodiments further provide a unique material comprising a crystalline compound and an amorphous compound which is solid at room temperature and molten at an elevated temperature and which provides for improved robustness as compared to the wax-based materials typically used in three-dimensional printing. As used herein, room temperature is defined as from about 20 to about 27° C.

It has been discovered that using a mixture of crystalline and amorphous compounds in phase change materials used in three-dimensional printing based on thermal stereolithography provides robust objects. Using this approach is surprising, however, due to the known properties of crystalline or amorphous materials. For crystalline materials, small molecules generally tend to crystallize when solidifying and low molecular weight organic solids are generally crystals. While crystalline materials are generally harder and more resistant, such materials are also much more brittle, so that printed matter made using a mainly crystalline ink composition is fairly sensitive to damage. For amorphous materials, high molecular weight amorphous materials, such as polymers, become viscous and sticky liquids at high temperature, but do not show sufficiently low viscosity at high temperatures. As a result, the polymers cannot be jetted at desirable jetting temperature 140° C.). In the present embodiments, however, it is discovered that a robust phase change material can be obtained through a blend of crystalline and amorphous compounds.

In addition, current world events, including energy and environmental policies, increasing and volatile oil prices, and public/political awareness of the rapid depletion of global fossil reserves, have created a need to find sustainable monomers derived from bio-renewable materials. Thus, the present embodiments have discovered crystalline-amorphous materials which are based on bio-renewable materials for use in forming robust and “more sustainable” three-dimensional objects. The term “bio-renewable” is used to mean a material comprised of one or more monomers that are derived from plant material. By using such bio-derived feedstock, which are renewable, manufacturers may reduce their carbon footprint and move to a zero-carbon or even a carbon-neutral footprint. Bio-renewable materials are also very attractive in terms of specific energy and emission savings. Utilizing bio-renewable feedstock can decrease the amount of waste targeted for landfills, and reduce the economic risks and uncertainty associated with reliance on petroleum imported from unstable regions.

It was previously discovered that using a mixture of crystalline and amorphous molecule compounds in phase change ink formulations provides robust inks, and in particular, phase change inks which demonstrate robust images on coated paper, as disclosed in U.S. Pat. No. 8,506,040 to Jennifer L. Belelie et al., and hereby incorporated by reference in its entirety. Print samples made with such phase change inks demonstrate better robustness with respect to scratch, fold, and fold offset as compared to currently available phase change inks.

The present embodiments provide a phase change material for use in forming three-dimensional objects that meets benchmark performance, competitive cost, and environmental sustainability. In particular, the present phase change materials incorporate aromatic rosin esters as the amorphous binder within the phase change formulation with a crystalline compound. In further embodiments, the phase change materials also comprise pigment, pigment dispersants and synergist. The aromatic rosin esters facilitate adhesion onto substrates or as well as successive layers formed from the phase change material. The aromatic rosin esters are also low cost stable raw materials. These materials are derived from rosin acids which are extracted from pine sap. The present embodiments thus provide a formulation for phase change materials that are based on crystalline and amorphous compounds which not only provide robust phase change materials, and in particular, phase change materials which provide robust three-dimensional objects, but are further derived from low cost, stable and bio-renewable materials. The present embodiments provide a new type of phase change materials for forming three-dimensional objects which comprise a blend of (1) crystalline and (2) amorphous compounds, generally in a weight ratio of from about 60:40 to about 95:5, respectively. In more specific embodiments, the weight ratio of the crystalline to amorphous compound is from about 65:35 to about 95:5, or is from about 70:30 to about 90:10.

Each compound or component imparts specific properties to the phase change materials, and the phase change materials incorporating a blend of these amorphous and crystalline compounds demonstrate excellent robustness. The crystalline compound in the phase change material drives the phase change through rapid crystallization on cooling. The crystalline compound also sets up the structure of the final three-dimensional object and creates a hard object by reducing the tackiness of the amorphous compound. The amorphous compounds provide tackiness and impart robustness to the three-dimensional object.

In embodiments, the present embodiments provide phase change materials that comprise up to 80% bio-renewable content, or from about 50 to about 80% bio-renewable content, or from about 70 to about 75% bio-renewable content. This means that up to 80% of the components are derived from renewable resources such as plants. The amorphous materials are inexpensive, biodegradable and from bio-renewable sources. The phase change materials made from these materials demonstrate excellent robustness as compared to conventionally used materials.

In embodiments, the phase change materials meet certain specific physical properties. For example, the phase change material has a melting point (Tₘₑₗₜ) of from about 60 to about 140° C., or from about 70 to about 130° C. In embodiments, the resulting phase change material has a crystallization point (T_{crys}) of from about 65 to about 110° C., or from about 70 to about 100° C. In further embodiments, the resulting phase change has a viscosity of from about 1 to about 22 cps, or from about 3 to about 12 cps, or from about 5 to about 10 cps at about 140° C. At room temperature, the resulting phase change material is a robust solid having a viscosity of about ≧10⁶ cps. The phase change materials of the present embodiments provide quick solidification upon cooling. In embodiments, the phase change materials reach a solid form having a viscosity of greater than 10⁶ cps within a time period of from about 1 seconds to about 10 seconds or from about 1 seconds to about 8 seconds upon cooling. As used herein, “cooling” means the removal of heat and return to ambient temperature. In further embodiments, the phase change material has an average particle size of from about 50 nm to about 400 nm, measured as described in U.S. patent application Ser. No. 13/680,322, which is hereby incorporated by reference.

The Amorphous Compound

In embodiments, the amorphous compound functions as the binder agent for the crystalline compound and any colorants or other minor additives. The present embodiments use aromatic rosin esters. These materials are derived from rosin acids which are extracted from pine sap. Natural rosin acids have double bonds. To obtain aromatic rosin acids, the materials are subjected to a disproportion (dehydrogenation) process to form aromatic bonds. The conversion of double bonds to aromatic bonds improves the thermal stability of the materials. The resulting carboxylic acid group is then reacted with different alcohols to give aromatic rosin esters.

In specific embodiments, the aromatic rosin ester is selected from the group consisting of

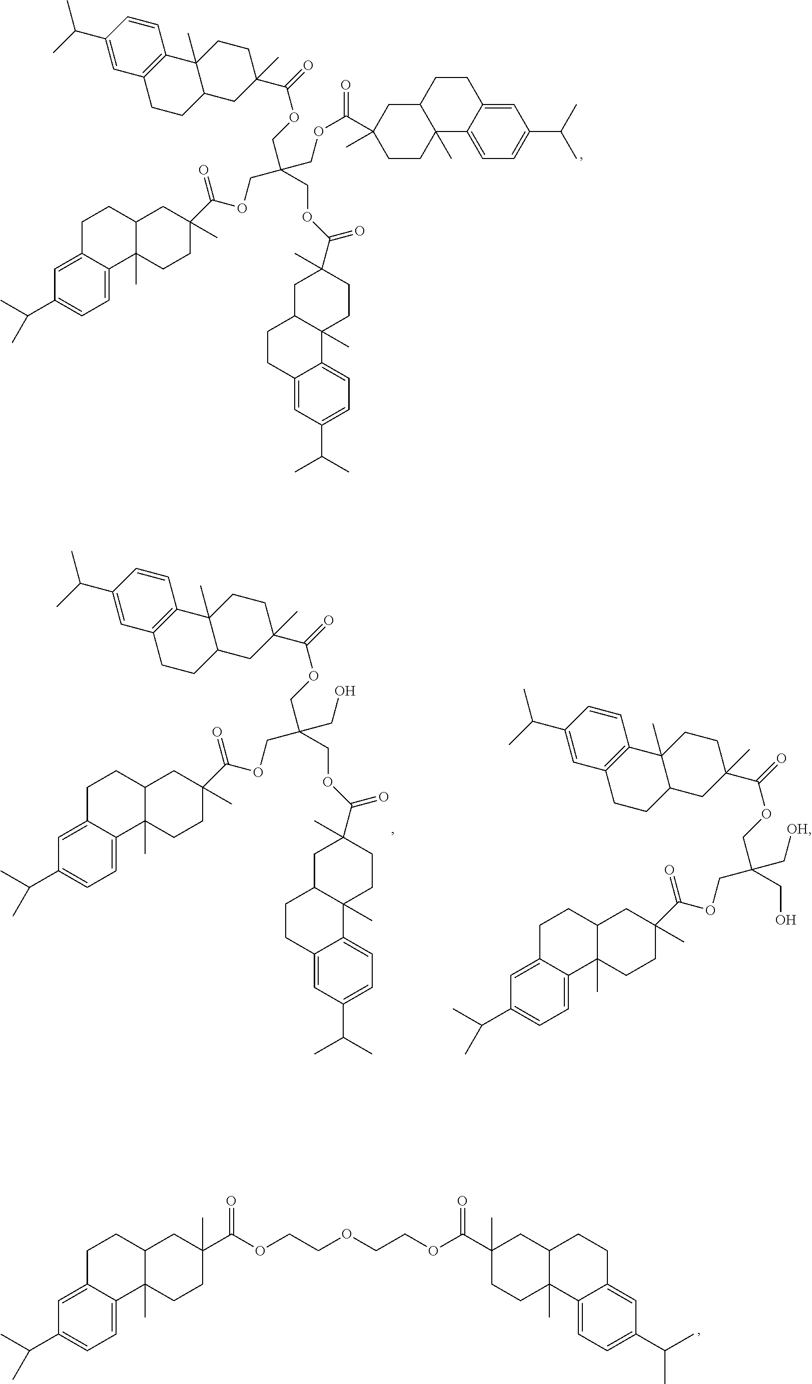

and mixtures thereof. In further embodiments, the amorphous compound comprises a mixture of

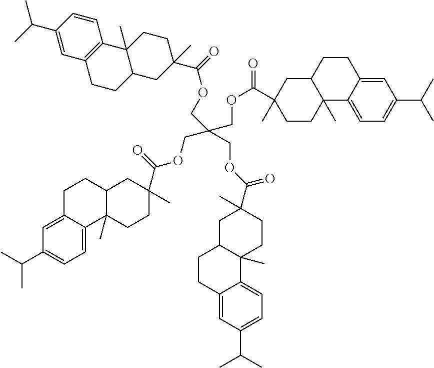 [SMILES: CC(C)c1ccc2c(c1)CCC1CC(C)(C(=O)OCC(COC(=O)C3(C)CCC4(C)c5ccc(C(C)C)cc5CCC4C3)(COC(=O)C3(C)CCC4(C)c5ccc(C(C)C)cc5CCC4C3)COC(=O)C3(C)CCC4(C)c5ccc(C(C)C)cc5CCC4C3)CCC21C]

in a range of from about 5% to about 15%, or from about 5% to about 10%, percent by weight of the total weight of the amorphous compound,

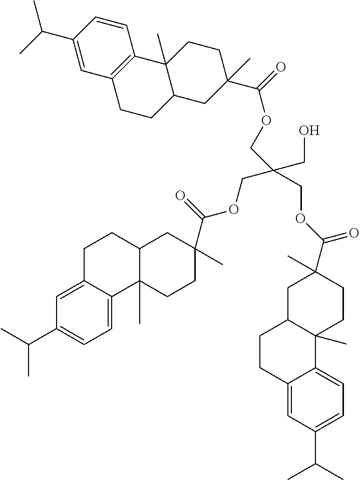 [SMILES: CC(C)c1ccc2c(c1)CCC1CC(C)(C(=O)OCC(CO)(COC(=O)C3(C)CCC4(C)c5ccc(C(C)C)cc5CCC4C3)COC(=O)C3(C)CCC4(C)c5ccc(C(C)C)cc5CCC4C3)CCC21C]

in a range of from about 1% to about 6%, or from about 1% to about 3%, percent by weight of the total weight of the amorphous compound,

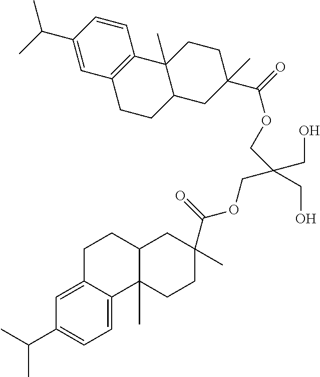 [SMILES: CC(C)c1ccc2c(c1)CCC1CC(C)(C(=O)OCC(CO)(CO)COC(=O)C3(C)CCC4(C)c5ccc(C(C)C)cc5CCC4C3)CCC21C]

in a range of from about 3% to about 8%, or from about 4% to about 6%, percent by weight of the total weight of the amorphous compound, and

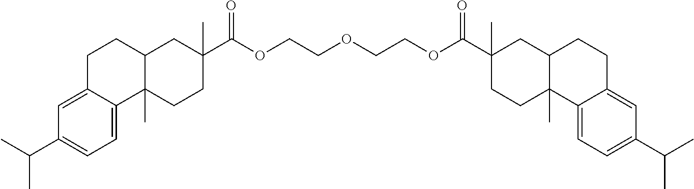 [SMILES: CC(C)c1ccc2c(c1)CCC1CC(C)(C(=O)OCCOCCOC(=O)C3(C)CCC4(C)c5ccc(C(C)C)cc5CCC4C3)CCC21C]

in a range of from about 75% to about 90%, or from about 75% to about 85%, percent by weight of the total weight of the amorphous compound.

An example of these commercial aromatic resins is Sylvatac RE 40, commercially available from Arizona Chemicals (Savannah, Ga.). It is a mixture of esters produced from the reaction of the rosin acid with 2-hydroxymethyl-1,3-propanediol and small amounts of pentaerythritol. Table 1 below shows the composition of Sylvatac RE 40 which was derived from MALDI analysis.

TABLE 1
Composition of Sylvatac RE 40

| Theoretical | | |
|---|---|---|
| Mass | | Percentage |
| (Da) | Structure | (%) |
| 1287.8562 | 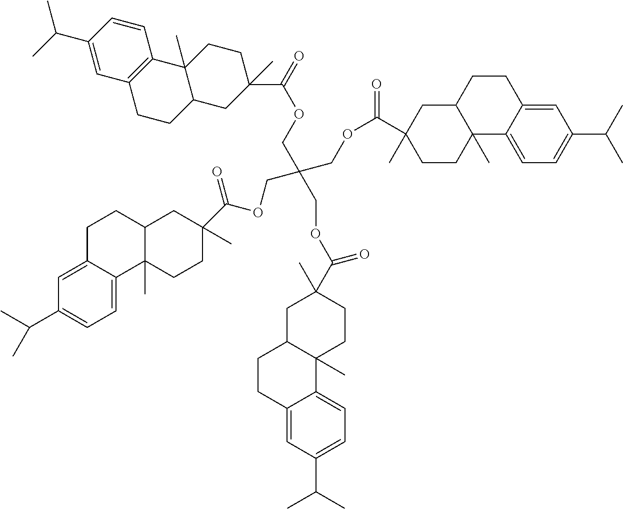 [SMILES: CC(C)c1ccc2c(c1)CCC1CC(C)(C(=O)OCC(COC(=O)C3(C)CCC4(C)c5ccc(C(C)C)cc5CCC4C3)(COC(=O)C3(C)CCC4(C)c5ccc(C(C)C)cc5CCC4C3)COC(=O)C3(C)CCC4(C)c5ccc(C(C)C)cc5CCC4C3)CCC21C] | 7.2 |
| 1005.6579 | 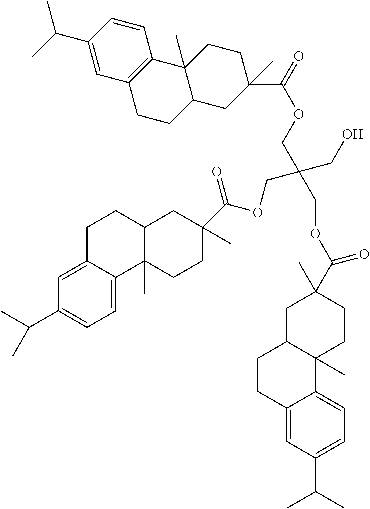 [SMILES: CC(C)c1ccc2c(c1)CCC1CC(C)(C(=O)OCC(CO)(COC(=O)C3(C)CCC4(C)c5ccc(C(C)C)cc5CCC4C3)COC(=O)C3(C)CCC4(C)c5ccc(C(C)C)cc5CCC4C3)CCC21C] | 2.2 |
| 723.4595 | 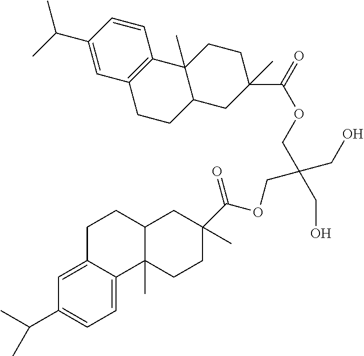 [SMILES: CC(C)c1ccc2c(c1)CCC1CC(C)(C(=O)OCC(CO)(CO)COC(=O)C3(C)CCC4(C)c5ccc(C(C)C)cc5CCC4C3)CCC21C] | 4.7 |
| 411.2506 | 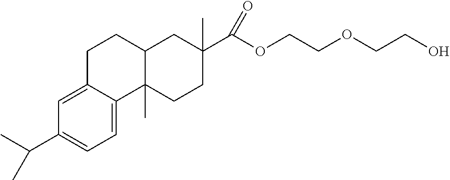 [SMILES: CC(C)c1ccc2c(c1)CCC1CC(C)(C(=O)OCCOCCO)CCC21C] | 1.9 |
| 255.2107 | 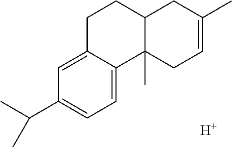 | 3.2 |
| 693.4489 | 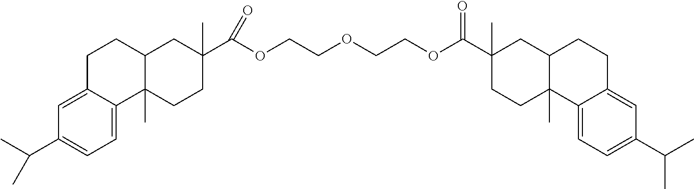 [SMILES: CC(C)c1ccc2c(c1)CCC1CC(C)(C(=O)OCCOCCOC(=O)C3(C)CCC4(C)c5ccc(C(C)C)cc5CCC4C3)CCC21C] | 80.8 |

Required properties for an amorphous binder to be used in the present embodiments for a robust phase change material include low Tg, low viscosity and stability at elevated temperatures. In embodiments, the amorphous compound has a Tg of from about −10° C. to about 30° C., or from about −10° C. to about 25° C., A number of commercial binders from Arizona Chemicals were assessed and below are some of the measured properties.

TABLE 2
Glass Transition Temperature (Tg) of Commercial Rosin Ester
Binders

| Binder | Tg (° C.) |
|---|---|
| Sylvatac RE 40 | 4.7 |
| Sylvatac RE 25 | −9.6 |
| Sylvatac RE 85 | 39 |
| Unitac 70 | 37.7 |
| Sylvalite RE 80HP | 35.8 |
| Sylvalite RE 85L | 39 |
| Sylvalite 100L | 50.4 |

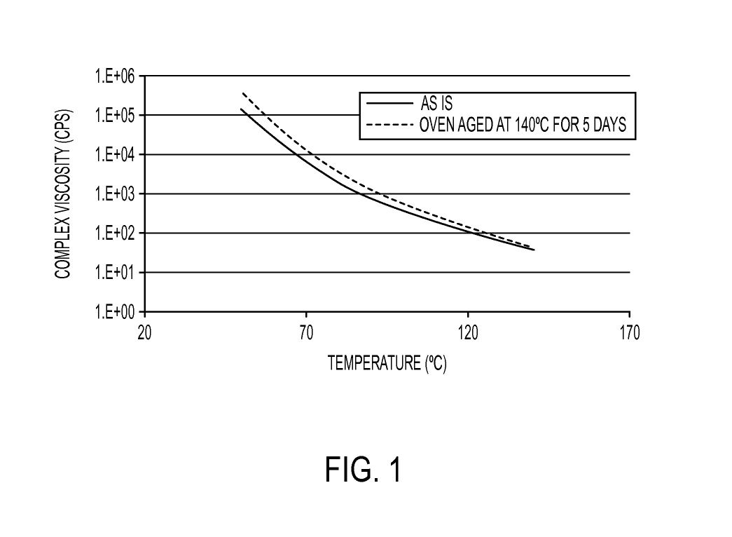

Phase change materials made from these amorphous binders need to be stable at the jetting temperature for prolonged periods of time. As a result the amorphous compounds also need to be stable at these high temperatures. In one embodiment, Sylvatac RE 40 was aged in the oven at 140° C. for 5 days and did not show any significant increase in viscosity (i.e., not increase more than 10 cps) as shown in FIG. 1.

In another embodiment, the phase change materials comprise Abitol E ester resins as amorphous binders, as disclosed in U.S. patent application Ser. No. 13/680,322 to Goredema et al., which is hereby incorporated by reference in its entirety. Rosin alcohol, Abitol E is derived from pine sap can be reacted with di-acids, such as succinic, itaconic, and azelaic acid, which are 100% BRC to form an amorphous binder agent for the phase change material composition of the present disclosure. Specific examples are represented by General Formulas I and/or II:

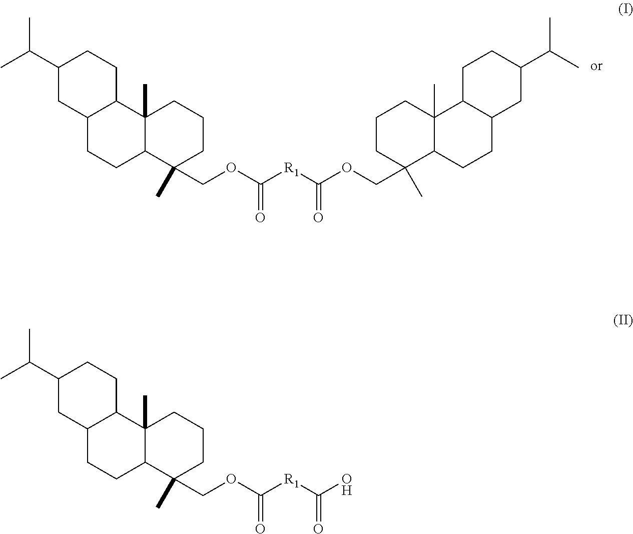

or a mixture of one or more compounds of General Formulas I and/or II; where R₁ is defined as an alkylene group, including substituted and unsubstituted alkylene groups, wherein heteroatoms either may or may not be present in the alkylene group; (b) an arylene group, including substituted and unsubstituted arylene groups, wherein heteroatoms either may or may not be present in the arylene group; (c) an arylalkylene group, including substituted and unsubstituted arylalkylene groups, wherein heteroatoms either may or may not be present in either or both of the alkyl portion and the aryl portion of the arylalkylene group; or (d) an alkylarylene group, including substituted and unsubstituted alkylarylene groups, wherein heteroatoms either may or may not be present in either or both of the alkyl portion and the aryl portion of the alkylarylene group; wherein two or more substituents can be joined together to form a ring.

Specific examples of resin esters include but are not limited to the structures shown below:

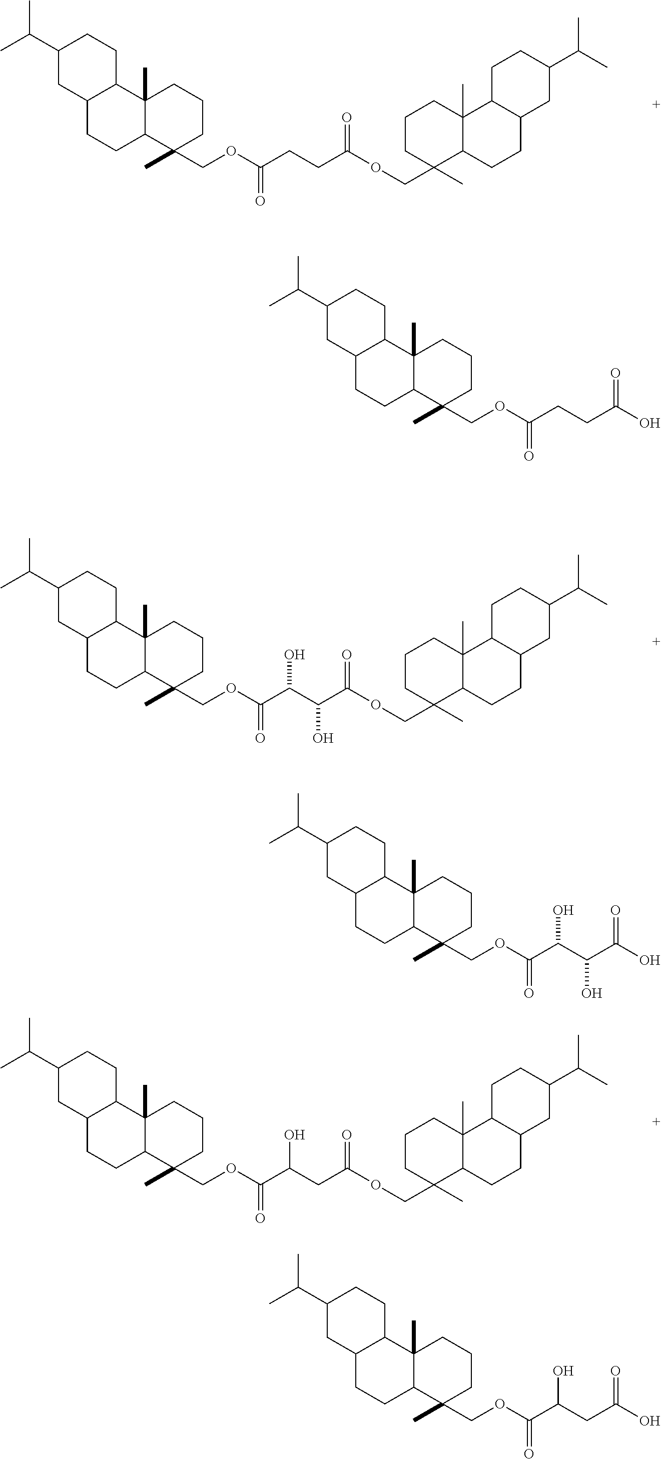

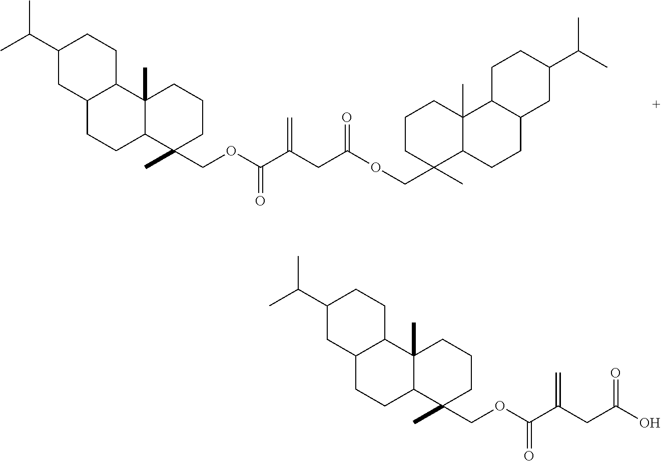

In yet other embodiments, phase change material compositions are provided comprising an amorphous amide derived from amine D. Amine D is a bio-renewable material derived from rosin acid, as disclosed in U.S. patent application Ser. No. 13/765,827 to Chopra et al., which is hereby incorporated by reference in its entirety. The amorphous binder has the formula

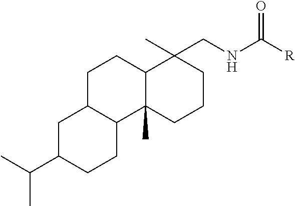

wherein R is selected from the group consisting of an alkyl group, an aryl group, an alkylaryl group, an arylalkyl group, and combinations thereof, as described herein; a crystalline compound; an optional synergist; an optional dispersant; and an optional colorant.

In further embodiments, phase change material composition is described comprising an amorphous compound of the formula

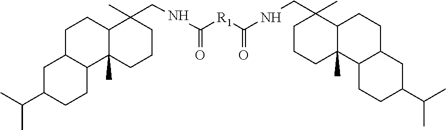

wherein R₁ is selected from the group consisting of an alkylene group, an arylene group, an alkylarylene group, an arylalkylene group, and combinations thereof. The amorphous compounds show relatively low viscosity (<10² centipoise (cps), or from about 1 to about 100 cps, or from about 5 to about 95 cps) near the jetting temperature 140° C., or from about 100 to about 140° C., or from about 105 to about 140° C.) but very high viscosity (>10⁵ cps) at room temperature.

In embodiments, the amorphous compound is present in an amount of from about 5 percent to about 40 percent by weight, or from about 10 percent to about 35 percent by weight, or from about 15 percent to about 30 percent by weight of the total weight of the phase change material.

In embodiments, the amorphous compounds are formulated with a crystalline compound to form a phase change material for forming three-dimensional objects. As previously stated, the acids used to make the rosin ester binders are derived from pine sap and have at least 80% bio-renewable content. The crystalline compounds used are likewise bio-renewable and have at least 80% bio-renewable content. The resulting phase change materials have a bio-renewable content of up to 80%. The resulting phase change materials show good rheological profiles. Samples created by the phase change materials exhibit excellent robustness.

The Crystalline Compound

As stated above, the crystalline compounds are all of high bio-renewable content. In particular, the fatty alcohols used to make the crystalline compounds are derived from plants giving these components at least 80% bio-renewable content.

Phase change materials of the present embodiments use the crystalline compounds listed in Table 3. The listed references are hereby incorporated by reference in their entireties.

TABLE 3
Crystalline Compounds

| Compound | | |
|---|---|---|
| No. | Structure | Reference |
| 1 | 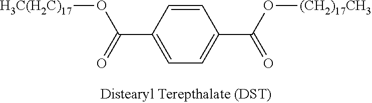 | U.S. Pat. application Ser. No. 13/681,106 to Goredema et al. |
| 2 | 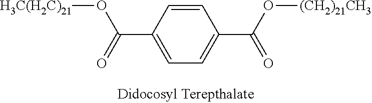 | U.S. Pat. application Ser. No. 13/681,106 to Goredema et al. |
| 3 | 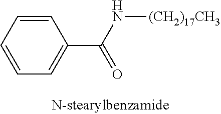 | U.S. Pat. application Ser. No. 13/765,827 to Chopra et al. |

The bio-renewable content is based on the weight percent of bio-based materials out of the total weight of the phase change material. All of the starting materials used to make the crystalline compounds of the present embodiments are inexpensive and safe.

The crystalline compounds show sharp crystallization, relatively low viscosity (≦12 centipoise (cps), or from about 0.5 to about 20 cps, or from about 1 to about 15 cps at a temperature of about 140° C., but very high viscosity (>10⁶ cps) at room temperature. These materials have a melting temperature (Tₘₑₗₜ) of less than 150° C., or from about 65 to about 150° C., or from about 66 to about 145° C., and a crystallization temperature (T_{crys}) of greater than 60° C., or from about 60 to about 140° C., or from about 65 to about 120° C. The AT between Tₘₑₗₜ and T_{crys} is less than about 55° C. The selected crystalline compounds provide the resulting phase change materials with fast crystallization properties.

In embodiments, the crystalline compound is present in an amount of from about 60 percent to about 95 percent by weight, or from about 65 percent to about 95 percent by weight, or from about 70 percent to about 90 percent by weight of the total weight of the phase change material.

Additives

The phase change materials of the present embodiments may further include conventional additives to take advantage of the known functionality associated with such conventional additives. Such additives may include, for example, at least one antioxidant, slip and leveling agents, clarifier, viscosity modifier, adhesive, plasticizer and the like.

The phase change material may optionally contain antioxidants to protect the images from oxidation and also may protect the components from oxidation while existing as a heated melt in the reservoir. Examples of suitable antioxidants include N,N′-hexamethylene bis(3,5-di-tert-butyl-4-hydroxy hydrocinnamamide) (IRGANOX 1098, available from BASF); 2,2-bis(4-(2-(3,5-di-tert-butyl-4-hydroxyhydrocinnamoyloxy)) ethoxyphenyl)propane (TOPANOL-205, available from Vertellus); tris(4-tert-butyl-3-hydroxy-2,6-dimethyl benzyl)isocyanurate (Aldrich); 2,2′-ethylidene bis(4,6-di-tert-butylphenyl)fluoro phosphonite (ETHANOX-398, available from Albermarle Corporation); tetrakis(2,4-di-tert-butylphenyl)-4,4′-biphenyl diphosphonite (Aldrich); pentaerythritol tetrastearate (TCI America); tributylammonium hypophosphite (Aldrich); 2,6-di-tert-butyl-4-methoxyphenol (Aldrich); 2,4-di-tert-butyl-6-(4-methoxybenzyl)phenol (Aldrich); 4-bromo-2,6-dimethylphenol (Aldrich); 4-bromo-3,5-didimethylphenol (Aldrich); 4-bromo-2-nitrophenol (Aldrich); 4-(diethyl aminomethyl)-2,5-dimethylphenol (Aldrich); 3-dimethylaminophenol (Aldrich); 2-amino-4-tert-amylphenol (Aldrich); 2,6-bis(hydroxymethyl)-p-cresol (Aldrich); 2,2′-methylenediphenol (Aldrich); 5-(diethylamino)-2-nitrosophenol (Aldrich); 2,6-dichloro-4-fluorophenol (Aldrich); 2,6-dibromo fluoro phenol (Aldrich); α-trifluoro-o-cresol (Aldrich); 2-bromo-4-fluorophenol (Aldrich); 4-fluorophenol (Aldrich); 4-chlorophenyl-2-chloro-1,1,2-tri-fluoroethyl sulfone (Aldrich); 3,4-difluoro phenylacetic acid (Adrich); 3-fluorophenylacetic acid (Aldrich); 3,5-difluoro phenylacetic acid (Aldrich); 2-fluorophenylacetic acid (Aldrich); 2,5-bis(trifluoromethyl)benzoic acid (Aldrich); ethyl-2-(4-(4-(trifluoromethyl)phenoxy)phenoxy)propionate (Aldrich); tetrakis(2,4-di-tert-butyl phenyl)-4,4′-biphenyl diphosphonite (Aldrich); 4-tert-amyl phenol (Aldrich); 3-(2H-benzotriazol-2-yl)-4-hydroxy phenethylalcohol (Aldrich); NAUGARD 76, NAUGARD 445, NAUGARD 512, and NAUGARD 524 (manufactured by Chemtura Corporation); and the like, as well as mixtures thereof. The antioxidant, when present, may be present in the phase change materials in any desired or effective amount, such as from about 0.25 percent to about 10 percent by weight of the phase change material or from about 1 percent to about 5 percent by weight of the phase change material.

Colorants

In embodiments, the phase change materials described herein also include a colorant. The phase change material may optionally contain colorants such as dyes or pigments. The colorants can be either from the cyan, magenta, yellow, black (CMYK) set or from spot colors obtained from custom color dyes or pigments or mixtures of pigments. Dye-based colorants are miscible with the base composition, which comprises the crystalline and amorphous compounds and any other additives.

Any desired or effective colorant can be employed in the phase change materials, including dyes, pigments, mixtures thereof, and the like, provided that the colorant can be dissolved or dispersed in the carrier and is compatible with the other components used in the phase change materials. The phase change materials can be used in combination with conventional phase change ink colorant materials, such as Color Index (C.I.) Solvent Dyes, Disperse Dyes, modified Acid and Direct Dyes, Basic Dyes, Sulphur Dyes, Vat Dyes, and the like. Examples of suitable dyes include Neozapon Red 492 (BASF); Orasol Red G (Pylam Products); Direct Brilliant Pink B (Oriental Giant Dyes); Direct Red 3BL (Classic Dyestuffs); Supranol Brilliant Red 3BW (Bayer AG); Lemon Yellow 6G (United Chemie); Light Fast Yellow 3G (Shaanxi); Aizen Spilon Yellow C-GNH (Hodogaya Chemical); Bemachrome Yellow GD Sub (Classic Dyestuffs); Cartasol Brilliant Yellow 4GF (Clariant); Cibanone Yellow 2G (Classic Dyestuffs); Orasol Black RLI (BASF); Orasol Black CN (Pylam Products); Savinyl Black RLSN (Clariant); Pyrazol Black BG (Clariant); Morfast Black 101 (Rohm & Haas); Diaazol Black RN (ICI); Thermoplast Blue 670 (BASF); Orasol Blue GN (Pylam Products); Savinyl Blue GLS (Clariant); Luxol Fast Blue MBSN (Pylam Products); Sevron Blue 5GMF (Classic Dyestuffs); Basacid Blue 750 (BASF); Keyplast Blue (Keystone Aniline Corporation); Neozapon Black X51 (BASF); Classic Solvent Black 7 (Classic Dyestuffs); Sudan Blue 670 (C.I. 61554) (BASF); Sudan Yellow 146 (C.I. 12700) (BASF); Sudan Red 462 (C.I. 26050) (BASF); C.I. Disperse Yellow 238; Neptune Red Base NB543 (BASF, C.I. Solvent Red 49); Neopen Blue FF-4012 (BASF); Fatsol Black BR (C.I. Solvent Black 35) (Chemische Fabriek Triade BV); Morton Morplas Magenta 36 (C.I. Solvent Red 172); metal phthalocyanine colorants such as those disclosed in U.S. Pat. No. 6,221,137, the disclosure of which is totally incorporated herein by reference, and the like. Polymeric dyes can also be used, such as those disclosed in, for example, U.S. Pat. No. 5,621,022 and U.S. Pat. No. 5,231,135, the disclosures of each of which are herein entirely incorporated herein by reference, and commercially available from, for example, Milliken & Company as Milliken Ink Yellow 869, Milliken Ink Blue 92, Milliken Ink Red 357, Milliken Ink Yellow 1800, Milliken Ink Black 8915-67, uncut Reactint Orange X-38, uncut Reactint Blue X-17, Solvent Yellow 162, Acid Red 52, Solvent Blue 44, and uncut Reactint Violet X-80.

Pigments are also suitable colorants for the phase change materials. Examples of suitable pigments include PALIOGEN Violet 5100 (BASF); PALIOGEN Violet 5890 (BASF); HELIOGEN Green L8730 (BASF); LITHOL Scarlet D3700 (BASF); SUNFAST Blue 15:4 (Sun Chemical); Hostaperm Blue B2G-D (Clariant); Hostaperm Blue B4G (Clariant); Permanent Red P-F7RK; Hostaperm Violet BL (Clariant); LITHOL Scarlet 4440 (BASF); Bon Red C (Dominion Color Company); ORACET Pink RF (BASF); PALIOGEN Red 3871 K (BASF); SUNFAST Blue 15:3 (Sun Chemical); PALIOGEN Red 3340 (BASF); SUNFAST Carbazole Violet 23 (Sun Chemical); LITHOL Fast Scarlet L4300 (BASF); SUNBRITE Yellow 17 (Sun Chemical); HELIOGEN Blue L6900, L7020 (BASF); SUNBRITE Yellow 74 (Sun Chemical); SPECTRA PAC C Orange 16 (Sun Chemical); HELIOGEN Blue K6902, K6910 (BASF); SUNFAST Magenta 122 (Sun Chemical); HELIOGEN Blue D6840, D7080 (BASF); Sudan Blue OS (BASF); NEOPEN Blue FF4012 (BASF); PV Fast Blue B2GO1 (Clariant); IRGALITE Blue GLO (BASF); PALIOGEN Blue 6470 (BASF); Sudan Orange G (Aldrich); Sudan Orange 220 (BASF); PALIOGEN Orange 3040 (BASF); PALIOGEN Yellow 152, 1560 (BASF); LITHOL Fast Yellow 0991 K (BASF); PALIOTOL Yellow 1840 (BASF); NOVOPERM Yellow FGL (Clariant); Ink Jet Yellow 4G VP2532 (Clariant); Toner Yellow HG (Clariant); Lumogen Yellow D0790 (BASF); Suco-Yellow L1250 (BASF); Suco-Yellow D1355 (BASF); Suco Fast Yellow D1355, D1351 (BASF); HOSTAPERM Pink E 02 (Clariant); Hansa Brilliant Yellow 5GX03 (Clariant); Permanent Yellow GRL 02 (Clariant); Permanent Rubine L6B 05 (Clariant); FANAL Pink D4830 (BASF); CINQUASIA Magenta (DU PONT); PALIOGEN Black L0084 (BASF); Pigment Black K801 (BASF); and carbon blacks such as REGAL 330™ (Cabot), Nipex 150 (Evonik) Carbon Black 5250 and Carbon Black 5750 (Columbia Chemical), and the like, as well as mixtures thereof.

Pigment dispersions in the phase change material base may be stabilized by synergists and dispersants. In specific embodiments the pigment may be stabilized by an amine based dispersant described in U.S. Pat. No. 7,973,186. In certain embodiments, the amine based dispersant has a structure of Formula II:

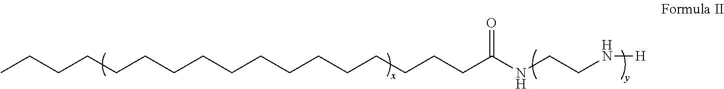

wherein x is from about 1 to about 10, and y is from about 10 to about 10,000. In certain of such embodiments, x is from about 2 to about 8 or from about 3 to about 5. In certain of such embodiments, y is from about 5 to about 20 or from about 9 to about 14. In a specific embodiment, the amine based dispersant has the following structure:

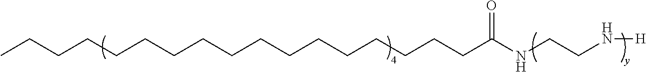

wherein y is from about 9 to about 14 (Compound A).

The dispersant in the pigment concentrate may be present in an amount of from about 2 percent weight to about 40 percent weight, from about 5 percent weight to about 35 percent weight, or from about 10 percent weight to about 30 percent weight based on the total weight of the pigment concentrate.

Generally, suitable pigments may be organic materials or inorganic. Magnetic material-based pigments are also suitable. Magnetic pigments include magnetic nanoparticles, such as for example, ferromagnetic nanoparticles.

Also suitable are the colorants disclosed in U.S. Pat. No. 6,472,523, U.S. Pat. No. 6,726,755, U.S. Pat. No. 6,476,219, U.S. Pat. No. 6,576,747, U.S. Pat. No. 6,713,614, U.S. Pat. No. 6,663,703, U.S. Pat. No. 6,755,902, U.S. Pat. No. 6,590,082, U.S. Pat. No. 6,696,552, U.S. Pat. No. 6,576,748, U.S. Pat. No. 6,646,111, U.S. Pat. No. 6,673,139, U.S. Pat. No. 6,958,406, U.S. Pat. No. 6,821,327, U.S. Pat. No. 7,053,227, U.S. Pat. No. 7,381,831 and U.S. Pat. No. 7,427,323, the disclosures of each of which are incorporated herein by reference in their entirety.

In embodiments, solvent dyes are employed. An example of a solvent dye suitable for use herein may include spirit soluble dyes because of their compatibility with the carriers disclosed herein. Examples of suitable spirit solvent dyes include Neozapon Red 492 (BASF); Orasol Red G (Pylam Products); Direct Brilliant Pink B (Global Colors); Aizen Spilon Red C-BH (Hodogaya Chemical); Kayanol Red 3BL (Nippon Kayaku); Spirit Fast Yellow 3G; Aizen Spilon Yellow C-GNH (Hodogaya Chemical); Cartasol Brilliant Yellow 4GF (Clariant); Pergasol Yellow 5RA EX (Classic Dyestuffs); Orasol Black RLI (BASF); Orasol Blue GN (Pylam Products); Savinyl Black RLS (Clariant); Morfast Black 101 (Rohm and Haas); Thermoplast Blue 670 (BASF); Savinyl Blue GLS (Sandoz); Luxol Fast Blue MBSN (Pylam); Sevron Blue 5GMF (Classic Dyestuffs); Basacid Blue 750 (BASF); Keyplast Blue (Keystone Aniline Corporation); Neozapon Black X51 (C.I. Solvent Black, C.I. 12195) (BASF); Sudan Blue 670 (C.I. 61554) (BASF); Sudan Yellow 146 (CI 12700) (BASF); Sudan Red 462 (CI 260501) (BASF), mixtures thereof and the like.

The colorant may be present in the phase change material in any desired or effective amount to obtain the desired color or hue such as, for example, at least from about 0.1 percent by weight of the phase change material to about 50 percent by weight of the phase change material, at least from about 0.2 percent by weight of the phase change material to about 20 percent by weight of the phase change material, and at least from about 0.5 percent by weight of the phase change material to about 10 percent by weight of the phase change material.

The phase change material can be prepared by any desired or suitable method. For example, each of the components of the phase change material can be mixed together, followed by heating the mixture to at least its melting point, for example from about 60° C. to about 150° C., 80° C. to about 145° C. and 85° C. to about 140° C. The colorant may be added before the base ingredients have been heated or after the base ingredients have been heated. When pigments are the selected colorants, the molten mixture may be subjected to grinding in an attritor or media mill apparatus to effect dispersion of the pigment in the carrier. The heated mixture is then stirred for about 5 seconds to about 30 minutes or more, to obtain a substantially homogeneous, uniform melt, followed by cooling the phase change material to ambient temperature (typically from about 20° C. to about 25° C.). The phase change materials are solid at ambient temperature. The phase change materials of the present embodiments employ thermal stereolithography to form three-dimensional objects. The method may employ an ink jet printhead. In the present embodiments, the method comprises providing a phase change material as described herein. The phase change material is heated to a temperature which melts the phase change material to a liquid such that it is jettable or having a viscosity of from about 1 to about 22 cps. In embodiments, the jetting temperature is at least 140° C., or from about 110 to about 135° C., or from about 115 to about 130° C. Once the phase change material is jettable, the method selectively jets the phase change material in layers. For example, the phase change material is jetted to form a first layer. The first layer may be formed on a substrate. The first layer is allowed to cool and solidify. As described above, the phase change material reaches a solid form having a viscosity of greater than 10⁶ cps within a time period of from about 1 to about 10 seconds or from about 1 to about 8 seconds upon cooling. Once solidified, subsequent layers are disposed onto the first layer, allowing each layer to cool and solidify before jetting the next layer, thus forming the three-dimensional object. In embodiments, the jetted layer is cooled to from about 115 to about 75° C. before jetting the subsequent layer. In forming non-planar layers, a support material may also be used to fill in the gaps as the non-planar layers are formed so as to provide support to the layers as they are being formed. The support material is subsequently removed from the end structure at the end of the process. In embodiments, the support material may comprise materials that have a melting point at least 20 to 30° C. lower than the phase change material melting point. Examples of suitable support materials include stearic acid, stearyl alcohol, bees wax, Carnuba wax, Kester wax K-82H, Kesterwax K-60P, Kester wax K-82P, Kester wax K-72 and any waxes with a melting point below 110° C.

The phase change materials described herein are further illustrated in the following examples. All parts and percentages are by weight unless otherwise indicated.

It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art, and are also intended to be encompassed by the following claims.

While the description above refers to particular embodiments, it will be understood that many modifications may be made without departing from the spirit thereof. The accompanying claims are intended to cover such modifications as would fall within the true scope and spirit of embodiments herein.

The presently disclosed embodiments are, therefore, to be considered in all respects as illustrative and not restrictive, the scope of embodiments being indicated by the appended claims rather than the foregoing description. All changes that come within the meaning of and range of equivalency of the claims are intended to be embraced therein.

### EXAMPLES

The examples set forth herein below are illustrative of different compositions and conditions that can be used in practicing the present embodiments. All proportions are by weight unless otherwise indicated. It will be apparent, however, that the present embodiments can be practiced with many types of compositions and can have many different uses in accordance with the disclosure above and as pointed out hereinafter.

### Example 1

### Preparation of the Phase Change Material

Bio-renewable amorphous and crystalline materials were either synthesized or purchased when commercially available. Several phase change materials were formulated by melt mixing amorphous and crystalline compounds and other components, as illustrated in Table 4.

To allow efficient jetting, the phase change formulations must be homogeneous in the melt. Therefore, the amorphous and crystalline materials must be miscible when molten and the crystalline compound must not phase separate upon standing at the jetting temperature for long periods of time.

TABLE 4
Sustainable Phase Change Materials

| | | Phase Change | Phase Change | Phase Change |
|---|---|---|---|---|
| | | Material 1 | Material 2 | Material 3 |
| Crystalline | Distearyl | | 76.48 | 78.4 |
| compound | Terepthalate (DST) | | | |
| | (BRC = 80%) | | | |
| | N-stearyl Benzamide | 76.48 | | |
| | (BRC = 72%) | | | |
| Amorphous component | Abitol E Succinic acid | | | 19.6 |
| | di-ester (100% BRC) | | | |
| | (as disclosed in U.S. | | | |
| | patent application Ser. | | | |
| | No. 13/680,322) | | | |
| | Sylvatac RE 40 (BRC | | 19.12 | |
| | ~80%) | | | |
| | Amine D-Hexanoic | 19.12 | | |
| | acid Amide (74% | | | |
| | BRC) (as disclosed | | | |
| | in U.S. patent application | | | |
| | Ser. No. 13/765,827) | | | |

| | | | |
|---|---|---|---|
| Amine Diespersant | 2 | 2 | |
| Described in US 7 973 | | | |
| 186 | | | |
| SunFlo SFD-B124 | 0.4 | 0.4 | |
| Synergist | | | |
| Keystone Solvent blue | | | 2 |
| 101 Dye | | | |
| Hostapern B4G Cyan | 2 | 2 | |
| Pigment | | | |
| Total | 100 | 100 | 100 |
| BRC (%)* | ~69 | ~78 | ~82 |
| Viscosity @ 140° C. (cps)** | 6.36 | 6.67 | 5.38 |
| Viscosity @ room T (cps) | >10⁶ | >10⁶ | >10⁶ |
| Tcryst. (° C.) (by rheology) | 85 | 80 | 80 |

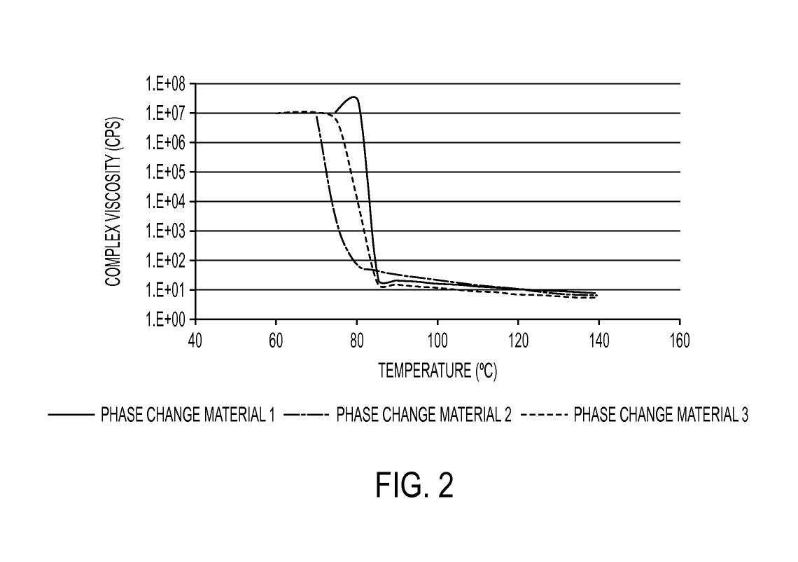

*Bio-renewable content is calculated by weight percent of bio-based materials out of total weight of phase change material
**Rheology profiles for the above formulations for the three phase change materials are shown in FIG. 2.

### Example 2

A 2×2 cm block is obtained by jetting phase change material 1 of Example 1 in a randomized pattern (layer to layer) on Xerox Durapaper® paper using a Xerox Phaser® 8400 solid ink printer, jetting at 124° C. Approximately 100 layers are printed, to give a final thickness of approximately 1 mm. Wait time between printing each layer is about 2 seconds. The printhead is moved as the image builds up to maintain a constant distance between the block and the printhead. The block is peeled off from the substrate upon cooling to room temperature, having good structural integrity. The resulting thin block can be handled in a normal manner and showed good resistance to break, demonstrating suitability of the phase change material 1 for a number of applications. It is expected that more complex structures can be printed in the same manner to produce mold or functional objects.

### Example 3

A 2×2 cm block is printed in the same way as in example 2 except Phase Change Material 2 of example 1 is used and is jetted at 120° C.

### Example 4

A 2×2 cm block is printed in the same way as in example 2 except Phase Change Material 3 of example 1 is used and is jetted at 120° C.

Based on the above properties, the materials of the present embodiments are expected to provide more robust structures than previously achieved through three-dimensional printing.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others. Unless specifically recited in a claim, steps or components of claims should not be implied or imported from the specification or any other claims as to any particular order, number, position, size, shape, angle, color, or material.

All the patents and applications referred to herein are hereby specifically, and totally incorporated herein by reference in their entirety in the instant specification.

What is claimed is:

1. A method for forming three-dimensional objects comprising:
providing a phase change material, wherein the phase change material comprises a crystalline compound and an amorphous compound and the phase change material comprises up to 80% bio-renewable content;
heating the phase change material to a jetting temperature;
jetting the phase change material in layers on top of one another, wherein each layer is allowed to cool and/or solidify before jetting a subsequent layer; and
forming a three-dimensional object from the cool and/or solidified layers.

2. The method of claim 1, wherein the crystalline compound has a viscosity of less than 12 cps at a temperature of about 140° C. and a viscosity of greater than 1×10⁶ cps at room temperature.

3. The method of claim 1, wherein the amorphous compound has a viscosity of less than 100 cps at a temperature of about 140° C. and a viscosity of greater than 1×10⁵ cps at room temperature.

4. The method of claim 1, wherein the jetting temperature is from about 110° C. to about 130° C.

5. The method of claim 1, wherein the jetted layer is cooled to from about 70° C. to about 40° C. before jetting the subsequent layer.

6. The method of claim 1, wherein the jetted layer is solidified before jetting the subsequent layer.

7. The method of claim 1, wherein cooling and/or solidifying the jetted layer takes from about 1 to about 10 seconds.

8. The method of claim 1, wherein the crystalline compound is selected from the group consisting of distearyl terepthalate, didocosyl terephthalate, N-stearyl benzamide, stereoisomers thereof and mixtures thereof.

9. The method of claim 1, wherein the amorphous compound is selected from the group consisting of abitol E succinic acid di-ester, amine D-hexanoic acid amine, stereoisomers thereof and mixtures thereof.

10. The method of claim 1, wherein the amorphous compound comprises an aromatic rosin ester selected from the group consisting of 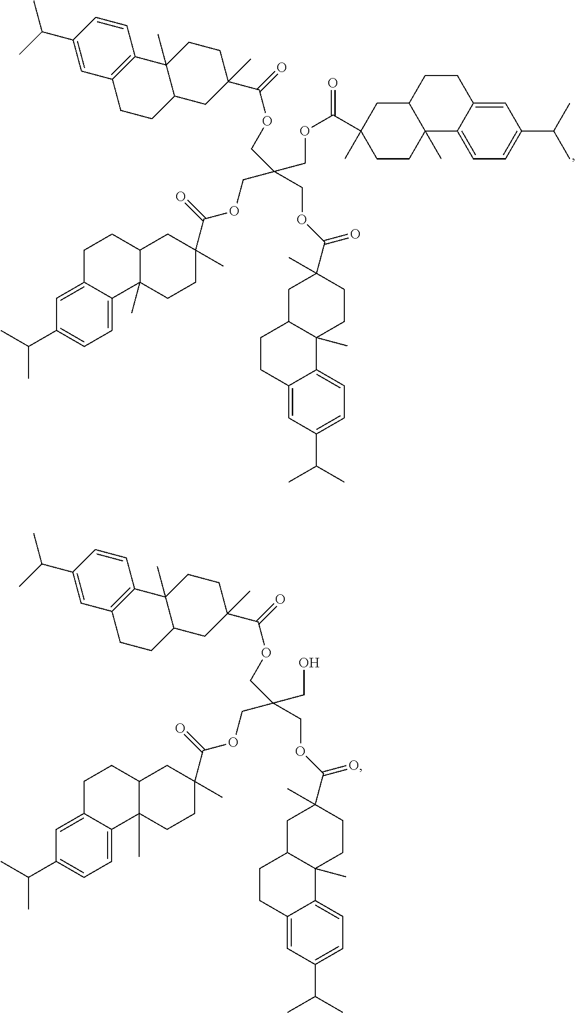 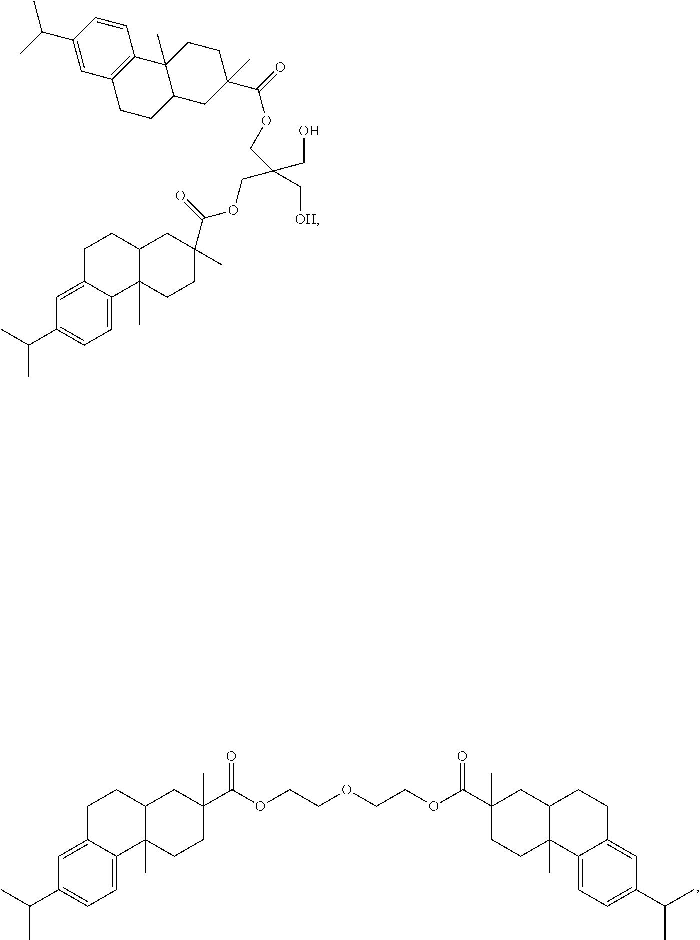 [SMILES: CC(C)c1ccc2c(c1)CCC1CC(C)(C(=O)OCC(CO)(CO)COC(=O)C3(C)CCC4(C)c5ccc(C(C)C)cc5CCC4C3)CCC21C ; CC(C)c1ccc2c(c1)CCC1CC(C)(C(=O)OCCOCCOC(=O)C3(C)CCC4(C)c5ccc(C(C)C)cc5CCC4C3)CCC21C]
and mixtures thereof.

11. The method of claim 1, wherein the phase change material further comprises one or more additives.

12. The method of claim 1, wherein the phase change material further comprises a colorant selected from the group consisting of a pigment, dye or mixtures thereof.

13. The method of claim 1, wherein the crystalline compound exhibits crystallization (T_{crys}) and melting (Tₘₑₗₜ) peaks according to differential scanning calorimetry and the difference between the peaks (Tₘₑₗₜ−T_{crys}) is less than 55° C.

14. The method of claim 1, wherein the crystalline compound has a melting point of above 65° C.

15. The method of claim 1, wherein the phase change material is jetted onto a support material that is removed after the three-dimensional object is formed.

16. The method of claim 1, wherein the amorphous compound has a T_{g} value of from about −10 to about 30° C.

17. A method for forming three-dimensional objects comprising:
providing a phase change material, wherein the phase change material comprises a crystalline compound and an amorphous compound and the phase change material comprises up to 80% bio-renewable content;
heating the phase change material to a jetting temperature;
jetting the phase change material to form a first layer;
allowing the first layer to cool and/or solidify; and
selectively jetting subsequent layers onto the first layer, either partially or entirely, wherein each layer is allowed to cool and/or solidify before jetting the next layer; and
forming a three-dimensional object from the cool and/or solidified layers.

18. The method of claim 17, wherein the crystalline and amorphous compounds are blended in a weight ratio of from about 65:35 to about 95:5, respectively.

19. A system for forming three-dimensional objects comprising:
a phase change material, wherein the phase change material comprises a crystalline compound and an amorphous compound and the phase change material comprises up to 80% bio-renewable content; and
a three dimensional printer comprising
a reservoir for holding the phase change material,
a heating element for heating the phase change material to a jetting temperature, and
a printhead for jetting the phase change material in successive layers to form a three-dimensional object.

20. The system of claim 19, wherein the crystalline compound has a viscosity of less than 12 cps at a temperature of about 140° C. and a viscosity of greater than 1×10⁶ cps at room temperature and wherein the amorphous compound has a viscosity of less than 100 cps at a temperature of about 140° C. and a viscosity of greater than 1×10⁵ cps at room temperature.
